(19) United States
(12) Patent Application Publication
(10) Pub. No.: US 2019/0136625 A1
(43) Pub. Date: May 9, 2019

(54) MECHANICAL STRUCTURE

(71) Applicant: WAN YU CHEN, NEW TAIPEI CITY (TW)

(72) Inventor: WAN YU CHEN, NEW TAIPEI CITY (TW)

(21) Appl. No.: 16/183,081

(22) Filed: Nov. 7, 2018

(30) Foreign Application Priority Data
Nov. 7, 2017 (CN) 201721472774.X
Feb. 13, 2018 (CN) 201820258435.X

(51) Int. Cl. E06C 7/50; F16B 7/04

(52) U.S. Cl. CPC E06C 7/50; E06C 1/32; F16B 7/044

(57) ABSTRACT

The present disclosure provides a mechanical structure, including a first portion, a second portion, the second portion including a first fixture, and a second fixture over the first fixture, a first connector, the first connector including a first end connected to the first portion, and a second end connected to the second portion, wherein the second end is connected to the first fixture when a first angle is between the first portion and the second portion, and the second end is connected to the second fixture when a second angle different from the first angle is between the first portion and the second portion.

### CROSS REFERENCE TO RELATED APPLICATION

This application claims the benefit of Chinese application CN201721472774.X, filed Nov. 7, 2017 and Chinese application CN201820258435.X, filed Feb. 13, 2018. The disclosure of these applications is hereby incorporated by reference in their entirety.

### BACKGROUND

When a user has intention to reach an elevated position, a mechanical structure, such as a supporter, a ladder, or the like, may provide an elevated standpoint and bear the weight of the user on such standpoint. In order to ameliorate safety and/or efficiency of using a mechanical structure as an elevated standpoint, an improved mechanical structure is entailed.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a perspective view showing a mechanical structure, in accordance with some embodiments of the present disclosure.

FIG. 2 is an enlarged schematic view showing a top portion of a mechanical structure, in accordance with some embodiments of the present disclosure.

FIG. 3A is a perspective view showing a connector, in accordance with some embodiments of the present disclosure.

FIG. 3B is an exploded view of a connector, in accordance with some embodiments of the present disclosure.

FIG. 3C is an exploded view of a connector, in accordance with some embodiments of the present disclosure.

FIG. 4 is a side view showing a mechanical structure under a first state, in accordance with some embodiments of the present disclosure.

FIG. 5A is a side view showing a mechanical structure under a second state, in accordance with some embodiments of the present disclosure.

FIG. 5B is a top view showing a mechanical structure under a second state, in accordance with some embodiments of the present disclosure.

FIG. 6A is a perspective view of a top portion of a mechanical structure, in accordance with some embodiments of the present disclosure.

FIG. 6B is a perspective view of a top portion of a mechanical structure, in accordance with some embodiments of the present disclosure.

FIG. 6C is an exploded view of a top portion of a mechanical structure, in accordance with some embodiments of the present disclosure.

FIG. 6D is an exploded view of a top portion of a mechanical structure, in accordance with some embodiments of the present disclosure.

FIG. 7A is a perspective view of a first portion of a mechanical structure, in accordance with some embodiments of the present disclosure.

FIG. 7B is a perspective view showing a mechanical structure, in accordance with some embodiments of the present disclosure.

FIG. 7C is an enlarged schematic view of a first portion of a mechanical structure, in accordance with some embodiments of the present disclosure.

FIG. 7D is a cross-sectional view of a first portion of a mechanical structure, in accordance with some embodiments of the present disclosure.

FIG. 7E is a perspective view of a first portion of a mechanical structure, in accordance with some embodiments of the present disclosure.

FIG. 7F is a cross-sectional view of a first portion of a mechanical structure, in accordance with some embodiments of the present disclosure.

FIG. 7G is a cross-sectional view of a strip, in accordance with some embodiments of the present disclosure.

FIG. 7H is a cross-sectional view of a first portion of a mechanical structure, in accordance with some embodiments of the present disclosure.

FIG. 7I is a cross-sectional view of a strip, in accordance with some embodiments of the present disclosure.

FIG. 8 is an enlarged schematic view showing a top portion of a mechanical structure, in accordance with some embodiments of the present disclosure.

FIG. 9 is an enlarged schematic view showing a top portion of a mechanical structure, in accordance with some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the respective testing measurements. Also, as used herein, the terms “substantially,” “approximately,” or “about” generally means within a value or range which can be contemplated by people having ordinary skill in the art. Alternatively, the terms “substantially,” “approximately,” or “about” means within an acceptable standard error of the mean when considered by one of ordinary skill in the art. People having ordinary skill in the art can understand that the acceptable standard error may vary according to different technologies. Other than in the operating/working examples, or unless otherwise expressly specified, all of the numerical ranges, amounts, values and percentages such as those for quantities of materials, durations of times, temperatures, operating conditions, ratios of amounts, and the likes thereof disclosed herein should be understood as modified in all instances by the terms “substantially,” “approximately,” or “about.” Accordingly, unless indicated to the contrary, the numerical parameters set forth in the present disclosure and attached claims are approximations that can vary as desired. At the very least, each numerical parameter should at least be construed in light of the number of reported significant digits and by applying ordinary rounding techniques. Ranges can be expressed herein as from one endpoint to another endpoint or between two endpoints. All ranges disclosed herein are inclusive of the endpoints, unless specified otherwise.

Conventionally, a mechanical structure may be restricted by the construction of a connector of the structure, thus cannot be spread to a greater angle, e.g. substantially spread to 180 degrees. Therefore, the convenience of the mechanical structure is limited by virtue of the utility of the mechanical structure in various environments or workplace.

In some other conventional mechanical structures, the mechanical structure may be spread to an obtuse angle; however, such conventional mechanical structures may be unstable, lack of protection, or prone to be damaged, thus exposing the user in the risk of falling or flipping, and further inducing casualties, or properties loss. In addition, such conventional mechanical structures may be hard to be operated, thence deteriorating time efficiency. The present disclosure provides an improved mechanical structure to ameliorate safety, improve efficiency, and sustain reliability.

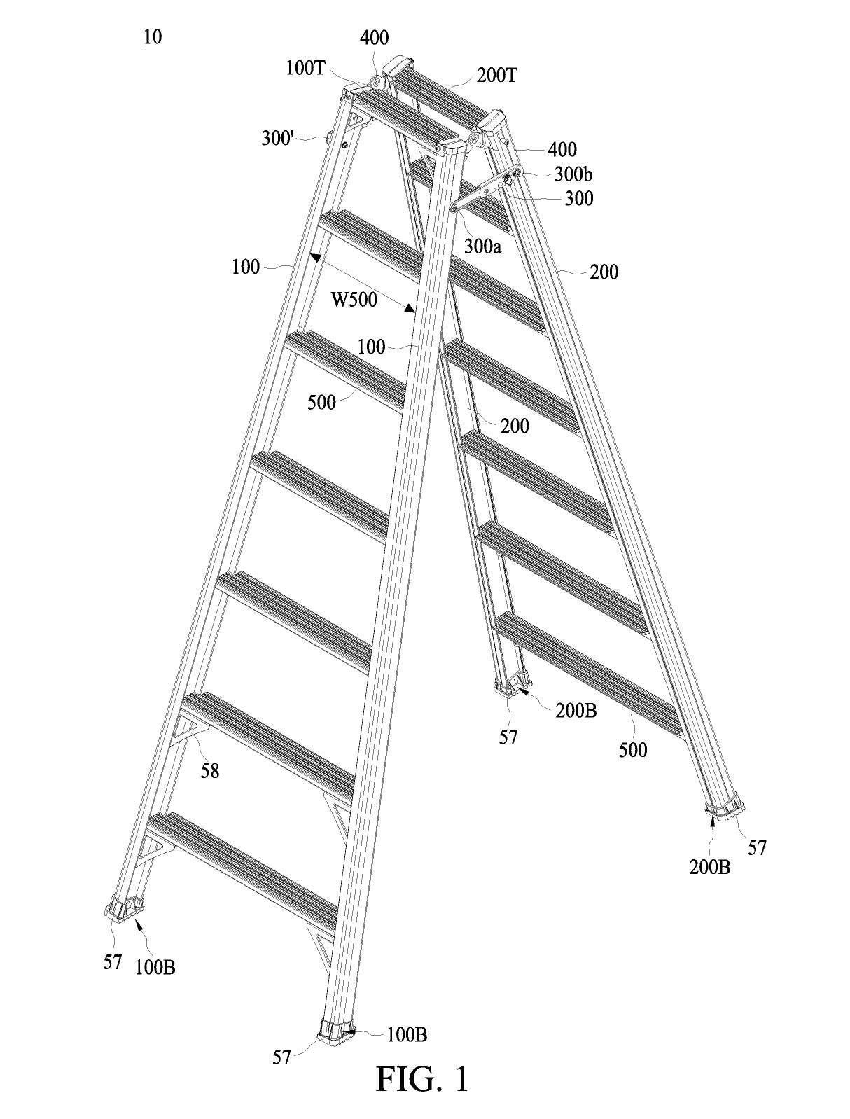

Referring to FIG. 1, FIG. 1 is a perspective view showing a mechanical structure, in accordance with some embodiments of the present disclosure. A mechanical structure 10 may include a first portion 100, a second portion 200, and a first connector 300. The first portion 100 and the second portion 200 may be made by a material having an adequate mechanical strength to bear a weight of human, such as metal, steel, stainless steel, aluminum, metal alloy, or other suitable materials. At least one of the first portion 100 and the second portion 200 has a connecting board 500, wherein a width W500 of the connecting board 500 may be at least greater than a width of a human foot, e.g. 3 cm, so that the connecting board 500 can serve as a standpoint for a user and thereby support the user. In some embodiments, a strengthening structure 58 for improving the strength of the connecting board 500 is connected between the connecting board 500 and the first portion 100, and/or connected between the connecting board 500 and the second portion 200. The strengthening structure 58 may be a structure similar to triangle shape, a hollowed triangle shape, polygon shape, or the like. The first portion 100 has a top surface 100T and the second portion 200 has a top surface 200T. In some embodiments, the first portion 100 has a shape tapering toward the top surface 100T, and the second portion 200 has a shape tapering toward the top surface 200T.

The first connector 300 has a first end 300a connected to the first portion 100, and a second end 300b connected to the second portion 200. The mechanical structure 10 may optionally include a second connector 300′ having a first end (not shown in FIG. 1) connected to the first portion 100, and a second end (not shown in FIG. 1) connected to the second portion 200. In some embodiments, the structure of the second connector 300′ is similar to the first connector 300, but is disposed on the opposite side of the mechanical structure 10, as the first connector 300 and the second connector 300′ are facing away from each other. For the purpose of conciseness, besides being disposed in substantially symmetrical or opposite fashion in some embodiments, the features of the second connector 300′ can be similar to the first connector 300 thereof, as duplicated explanations are omitted.

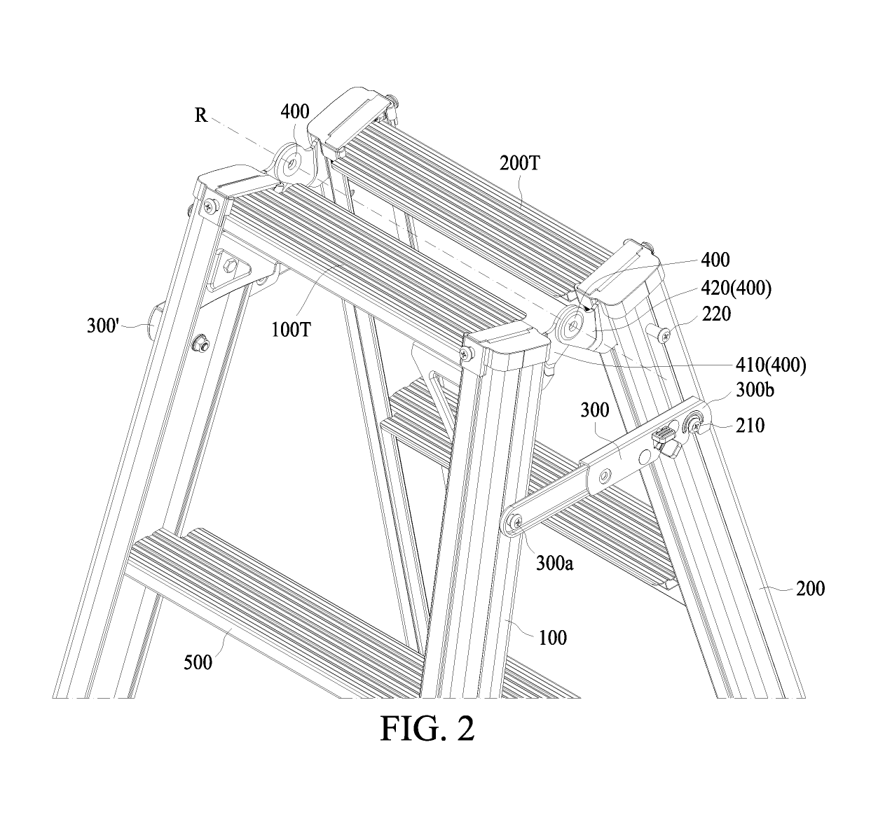

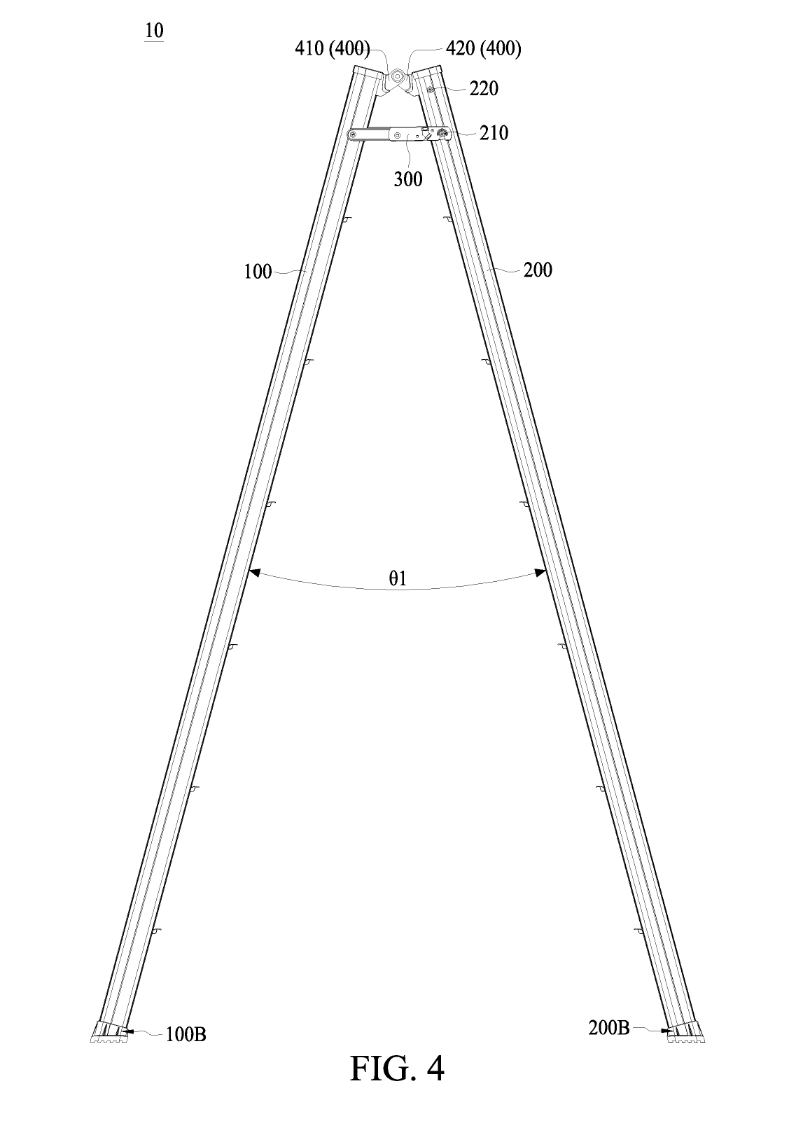

In some embodiments, the mechanical structure 10 further include a hinge 400 connected between the first portion 100 and the second portion 200, as the details of the hinge 400 will be subsequently discussed in FIG. 4 to FIG. 6B. A first portion 410 of the hinge 400 is connected to the first portion 100 of the mechanical structure 10 and a second portion 420 of the hinge 400 is connected to the second portion 200 of the mechanical structure 10. The hinge 400 allows the first portion 100 and/or the second portion 200 to relatively rotates around a rotational axis R (as shown in FIG. 2), as an end 100B of the first portion 100 distal to the top surface 100T can move toward or move away from an end 200B of the second portion 200 distal to the top surface 200T. In some embodiments, the mechanical structure 10 may include two or more hinges 400, each on one side of the top portion of the mechanical structure 10, to facilitate the smoothness and the stability of the rotation thereof.

In some embodiments, the mechanical structure 10 further include a pad 57 covering a bottom surface of the first portion 100 and/or a bottom surface of the second portion 200. The pad 57 may be materials with higher friction coefficient, such as plastic, rubber, polymer, or other suitable compositions. The pad 57 prevents the mechanical structure 10 from easily flipping over or gliding, thus reduces the risk of inducing injuries.

Referring to FIG. 2, FIG. 2 is an enlarged schematic view showing a top portion of a mechanical structure, in accordance with some embodiments of the present disclosure. The mechanical structure 10 further include a first fixture 210 and a second fixture 220 disposed on the second portion 200, wherein the second fixture 220 is over the first fixture 210. The second end 300b of the first connector 300 can be fixated to the first fixture 210 or the second fixture 220. In some embodiments, a third fixture (not shown in FIG. 2) and a fourth fixture (not shown in FIG. 2) over the third fixture is disposed on the same side of the second connector 300′, as the second end of the second connector 300′ can be connected to the second portion 200 through the third fixture or the fourth fixture.

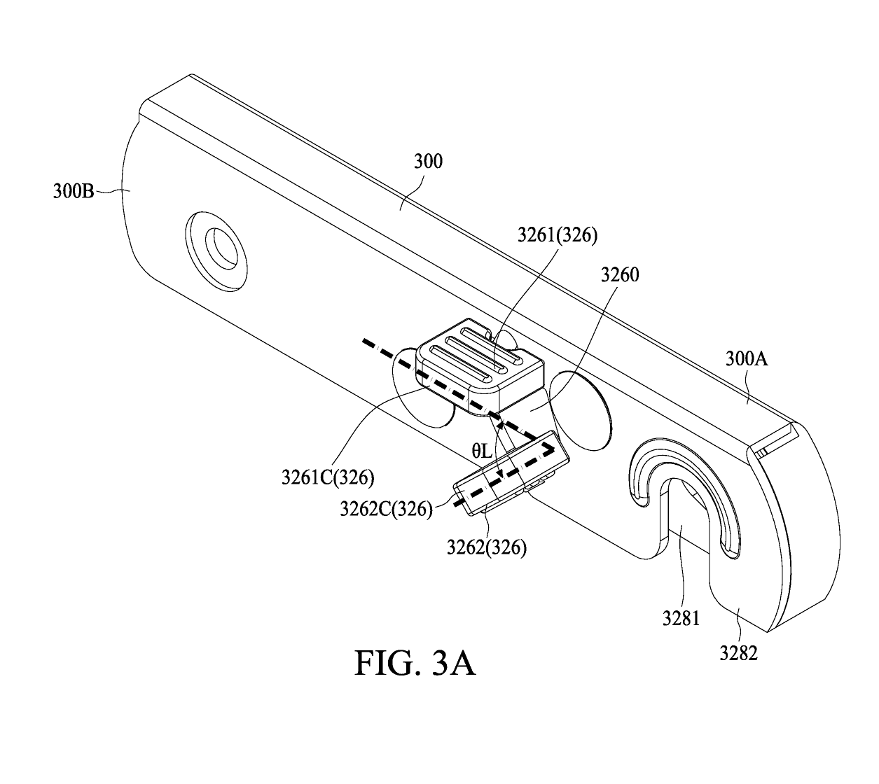

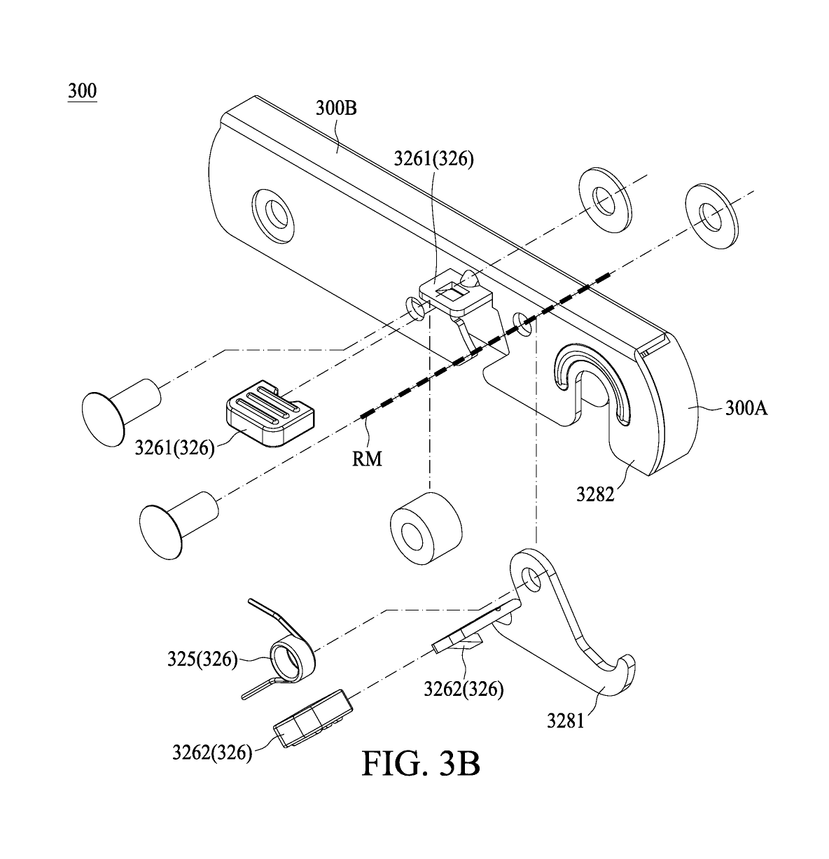

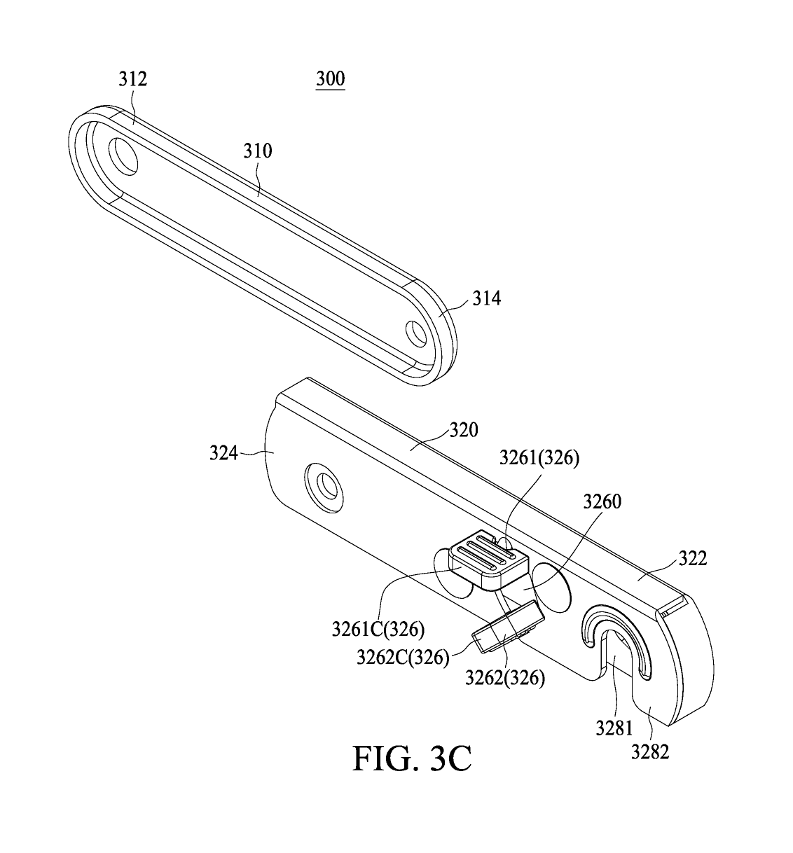

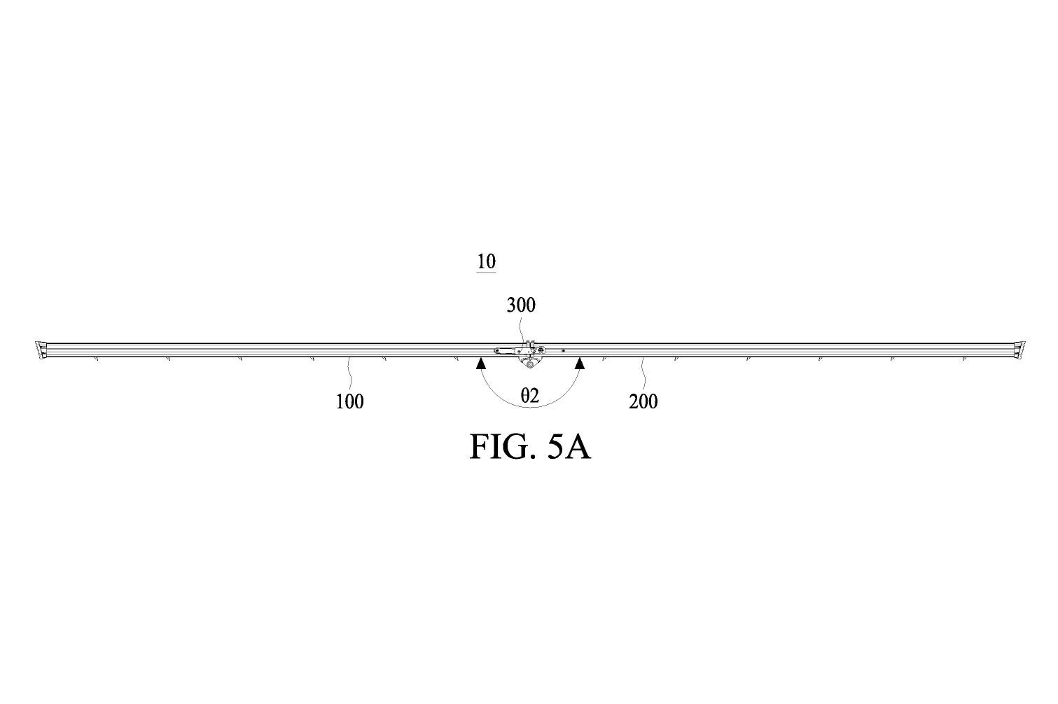

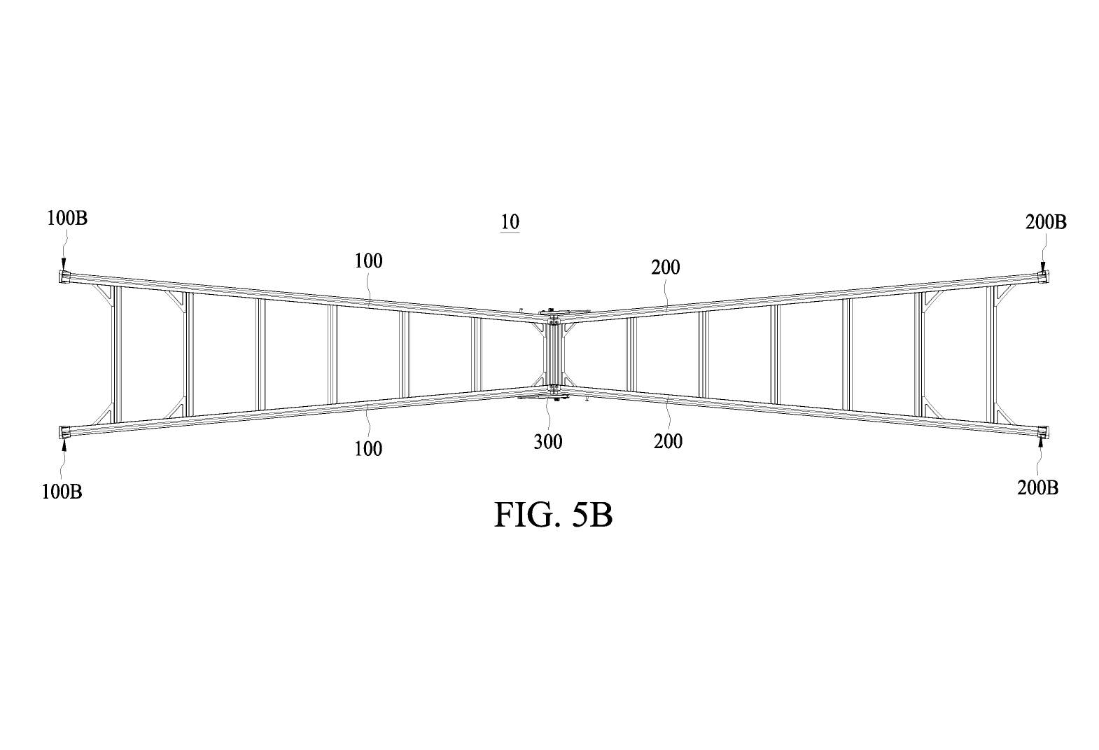

Referring to FIG. 3A, FIG. 4, FIG. 5A and FIG. 5B, FIG. 3A is a perspective view showing a connector, FIG. 4 is a side view showing a mechanical structure under a first state, in accordance with some embodiments of the present disclosure, FIG. 5A is a side view showing a mechanical structure under a second state, in accordance with some embodiments of the present disclosure, FIG. 5B is a top view showing a mechanical structure under a second state, in accordance with some embodiments of the present disclosure. The first connector 300 may include an operative portion 326 to control the first connector 300 to be fixated to the first fixture 210 or second fixture 220, or unfixed from the first fixture 210 or second fixture 220. The operative portion 326 may be between the first end 300a and the second end 300b.

When the first connector 300 is fixated to the first fixture 210, as shown in FIG. 4, a first angle θ₁ is between the first portion 100 and the second portion 200, as such position is denoted as a first state. And by operating the operative portion 326 to unfix the first connector 300 from the first fixture 210, the first portion 100 and the second portion 200 can thereby rotate around the rotational axis R (shown in FIG. 2). The first connector 300 can be fixated to the second fixture 220, as shown in FIG. 5A and FIG. 5B, thus a second angle θ₂ different from the first angle θ₁ is between the first portion 100 and the second portion 200, herein such position can be denoted as a second state. In some embodiments, the second angle θ₂ is greater than the first angle θ₁. In some embodiments, the first angle θ₁ is an acute angle and the second angle θ₂ is an obtuse angle. In some embodiments, the second angle θ₂ is identical to 180 degrees or substantially identical to 180 degrees, within an acceptable tolerance. The first connector 300 can be unfixed from the second fixture 220 and fixated to the first fixture 210, as an angle between the first portion 100 and the second portion 200 changes from the second angle θ₂ to the first angle θ₁.

As shown in FIG. 2 and FIG. 5B, it is noteworthy that the top surface 100T and the top surface 200T does not interfere each other during the process of the mechanical structure 10 transferring between the first state and the second state.

Referring to FIG. 3A and FIG. 3B, FIG. 3B is an exploded view of a connector, in accordance with some embodiments of the present disclosure. In some embodiments, the operative portion 326 at least includes a first lever 3261 and a second lever 3262. The operative portion 326 may further include an elastic member 325 connected between the first lever 3261 and the second lever 3262. In some embodiments, the first lever 3261 is fixed on the first connector 300 and the second lever 3262 is rotatably connected to the first connector 300, so that the second lever can rotate along an axis RM. When a leverage angle θ_{L} between the first lever 3261 and the second lever 3262 is reduced by external force applied on the first lever 3261 and/or the second lever 3262, i.e. from a first leverage angle to a second leverage angle less than the first leverage angle, the elastic member 325 allows a distance between the first lever 3261 and the second lever 3262 to reduce, and stores elastic potential energy thereof. In some embodiments, the elastic member 325 can be a torsion spring, a coil, a spring, a hinge, or other suitable structures which can store potential energy. An aperture 3260 is disposed between the first lever 3261 and the second lever 3262 to allow the leverage angle θ_{L} between the first lever 3261 and the second lever 3262 to be smoothly changed within a predetermined range.

When the external force applied on the first lever 3261 and/or the second lever 3262 is substantially reduced or removed therefrom, the elastic member 325 provides a torque and/or a force to increase the leverage angle θ_{L} between the first lever 3261 and the second lever 3262, i.e. from the second leverage angle to the first leverage angle, which is greater than the second leverage angle. In some embodiments, the first leverage angle and the second leverage angle are acute angles, so that the operative portion 326 can be operated easily by virtue of applying force thereon. In some embodiments, for the purpose of improving safety, a sleeve 3261C and a sleeve 3262C may at least cover a portion of the first lever 3261 and the second lever 3262 respectively so that a user can apply force on a mild surface, wherein a sharp edge, burr, metal edge, or rough surface can be covered by the sleeve 3261C and the sleeve 3262C, thus incise injury can be avoided.

The sleeve 3261C and the sleeve 3262C may include plastic, polymer, rubber, organic substances, or the like. In some embodiments, the first lever 3261 and the second lever 3262 may include a mating engagement structure, such as protrusions and recesses, to ameliorate adhesion between the sleeve 3261C and the sleeve 3262C, respectively.

The first connector 300 may further include a clip 3281 connected to the second lever 3262 and a mating part 3282. The clip 3281 may move in accordance with the second lever 3262, or alternately stated, movement of the clip 3281 may be controlled by the operative portion 326. In some embodiments, the clip and the second lever 3262 are manufactured as an integrated piece. In some embodiments, the clip 3281 has a curved shape, such as hook shape. The clip 3281 can fixate the first connector 300 to the first fixture 210 or the second fixture 220.

When the leverage angle θ_{L} between the first lever 3261 and the second lever 3262 is at the first leverage angle, the clip 3281 may secure the first fixture 210 or the second fixture 220 by applying a force thereon against the mating part 3282, wherein the force can be provided by the elastic member 325, so that the first connector 300 may not be unfixed from the first fixture 210 or the second fixture 220 without utilizing the operative portion 326. Thereby the mechanical structure 10 may not accidentally folded or moved in an undesired fashion. In some embodiments, the mating part 3282 may have a recess to accommodate at least a portion of the clip 3281 to further improve secureness. Referring to FIG. 4, with the first portion 100 and the first fixture 210 of the second portion 200 being connected by the first connector 300, the mechanical structure 10 may stand on the end 100B and the end 200B in first state. While referring to FIG. 5B, with the first portion 100 and the second fixture 220 of the second portion 200 being connected by the first connector 300, one of the end 100B and the end 200B supports the mechanical structure 10 to stand in second state, with another one in contact with another surface, such as a wall or a vertical surface.

Referring back to FIG. 3A and FIG. 3B, When the leverage angle θ_{L} between the first lever 3261 and the second lever 3262 is increased to an angle greater than the first leverage angle (e.g. second leverage angle), the clip 3281 moves away from the mating part 3282 thus the first connector 300 can be unfixed and disconnected from the first fixture 210 or the second fixture 220, and the first portion 100 and the second portion 200 can thereby be rotated around the rotational axis R.

Referring to FIG. 3C, FIG. 3C is an exploded view of a connector, in accordance with some embodiments of the present disclosure. In some embodiments, the first connector 300 includes a first link 310 and a second link 320, wherein a first end 312 of the first link 310 is connected to the first portion 100, and a second end 314 of the first link 310 is connected to the second link 320. A first end 324 of the second link 320 is connected to the first link 310 and a second end 322 of the second link 320 is opposite to the first end 324 of the second link 320. The second link 320 may include the operative portion 326, the clip 3281, the mating part 3282, the elastic member 325 as aforementioned in FIG. 3A and FIG. 3B. The first link 310 may provide additional length to the first connector 300. It is noteworthy that the second end 322 of the second link 320 can be deemed as the second end 300b of the first connector 300, and the first end 312 of the first link 310 can be deemed as the first end 300a of the first connector 300.

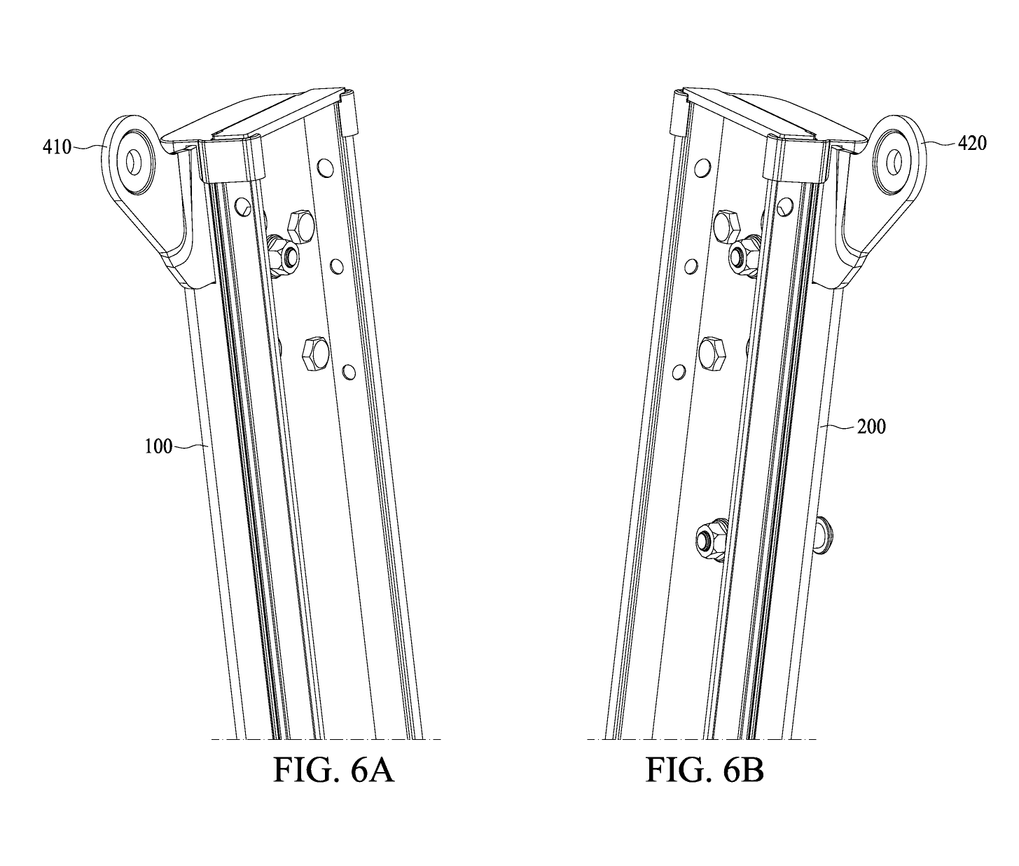

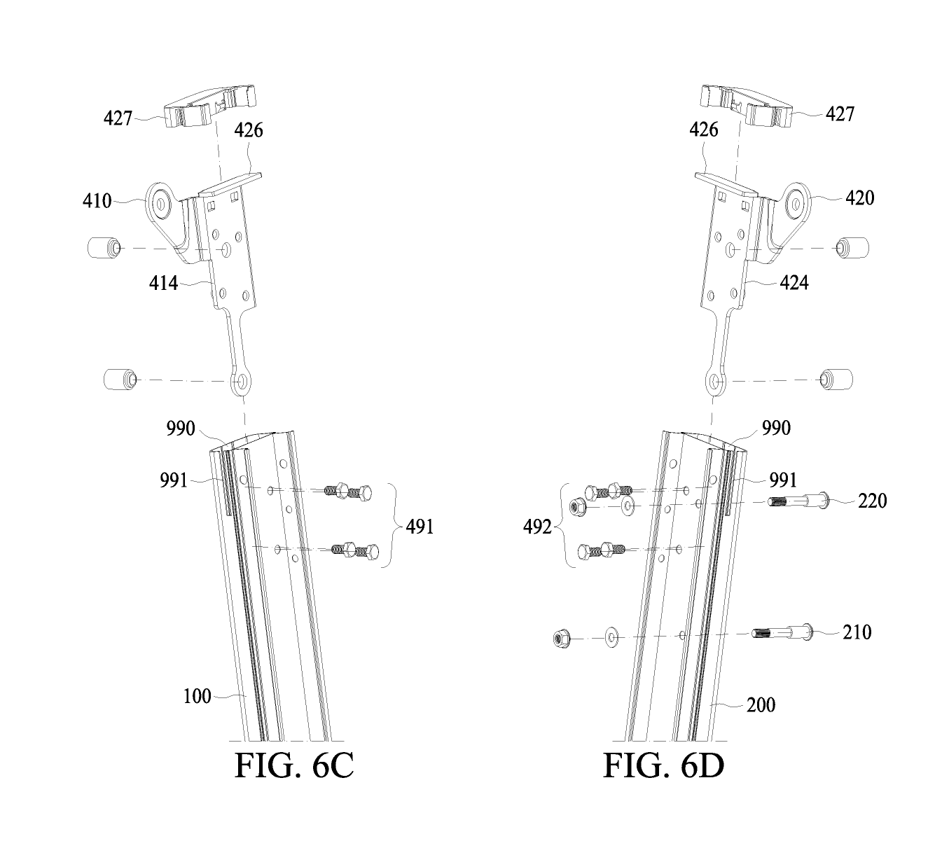

Referring to FIG. 6A and FIG. 6B, FIG. 6A is a perspective view of a top portion of a mechanical structure, FIG. 6B is a perspective view of a top portion of a mechanical structure, in accordance with some embodiments of the present disclosure. The first portion 410 of the hinge 400 is connected and fixed to the first portion 100 of the mechanical structure 10, and the second portion 420 of the hinge 400 is connected and fixed to the second portion 200 of the mechanical structure 10. The first portion 410 of the hinge 400 and the second portion 420 of the hinge 400 can rotate around a rotational axis R (shown in FIG. 2).

Referring to FIG. 6C and FIG. 6D, FIG. 6C is an exploded view of a top portion of a mechanical structure, FIG. 6D is an exploded view of a top portion of a mechanical structure, in accordance with some embodiments of the present disclosure. Each of the first portion 100 and the second portion 200 may include a hollowed chamber 990, as a portion of the first portion 410 of the hinge 400 and a portion of the second portion 420 of the hinge 400 can be accommodated in the hollowed chamber 990 of the first portion 100 and the hollowed chamber 990 of the second portion 200 respectively. An extension portion 414 connected to the first portion 410 of the hinge 400 is fixated to an inner surface of the hollowed chamber 990 of the first portion 100 by a first fixing member 491; while an extension portion 424 connected to the second portion 420 of the hinge 400 is fixated to an inner surface of the hollowed chamber 990 of the second portion 200 by a second fixing member 492. In some embodiments, the insertion direction of the first fixing member 491 and the second fixing member 492 are opposite to the first fixture 210 for safety and aesthetical purpose since the first fixing member 491 and the second fixing member 492 may not be exposed on an outer surface of the first portion 100 and the second portion 200 which disposes the first connector 300 or the second connector 300′. In some embodiments, the first fixing member 491 and the second fixing member 492 may include screw, nut, bolt, and/or other suitable fixtures; while the extension portion 414 and the extension portion 424 are mating members of the first fixing member 491 and the second fixing member 492, which may include inner thread, thread, socket, or the like.

In some embodiments, each of the first portion 100 and the second portion 200 has a slot 991 so that a portion of the first portion 410 of the hinge 400 and a portion of the second portion 420 of the hinge 400 can be respectively inserted therein. The slot 991 may avoid structure interference and further improve the stability of the hinge 400 by contacting at least two sides of each of the first portion 410 of the hinge 400 and a portion of the second portion 420 of the hinge 400.

In some embodiments, each of the extension portion 414 and the extension portion 424 has a top portion 426 to respectively contact with a top surface of the first portion 100 and a top surface of the second portion 200 directly, thus the hinge 400 can be fixated with improved stability. A cap 427 may be disposed above the extension portion 414 and the extension portion 424 to further improve stability of the hinge 400 and avoid without inducing incised injury.

In some embodiments, at least a portion of the first fixture 210 and a portion of the second fixture 220 are in the hollowed chamber 990 of the second portion 200. The first fixture 210 and the second fixture 220 may penetrate through the second fixing member 492 to further alleviate the risk of the hinge 400 being unstable.

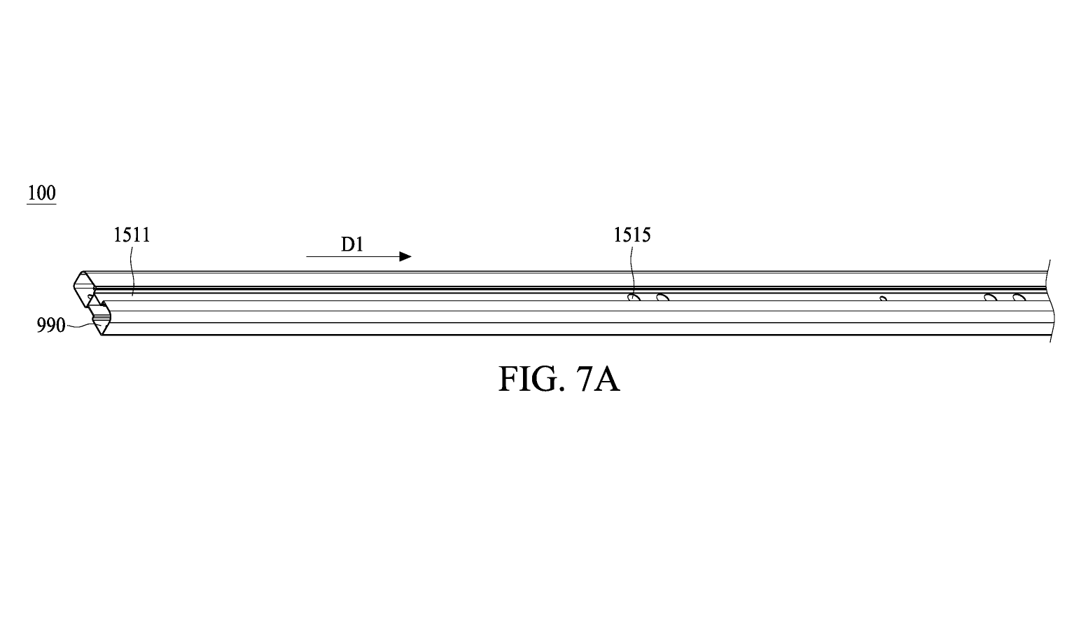

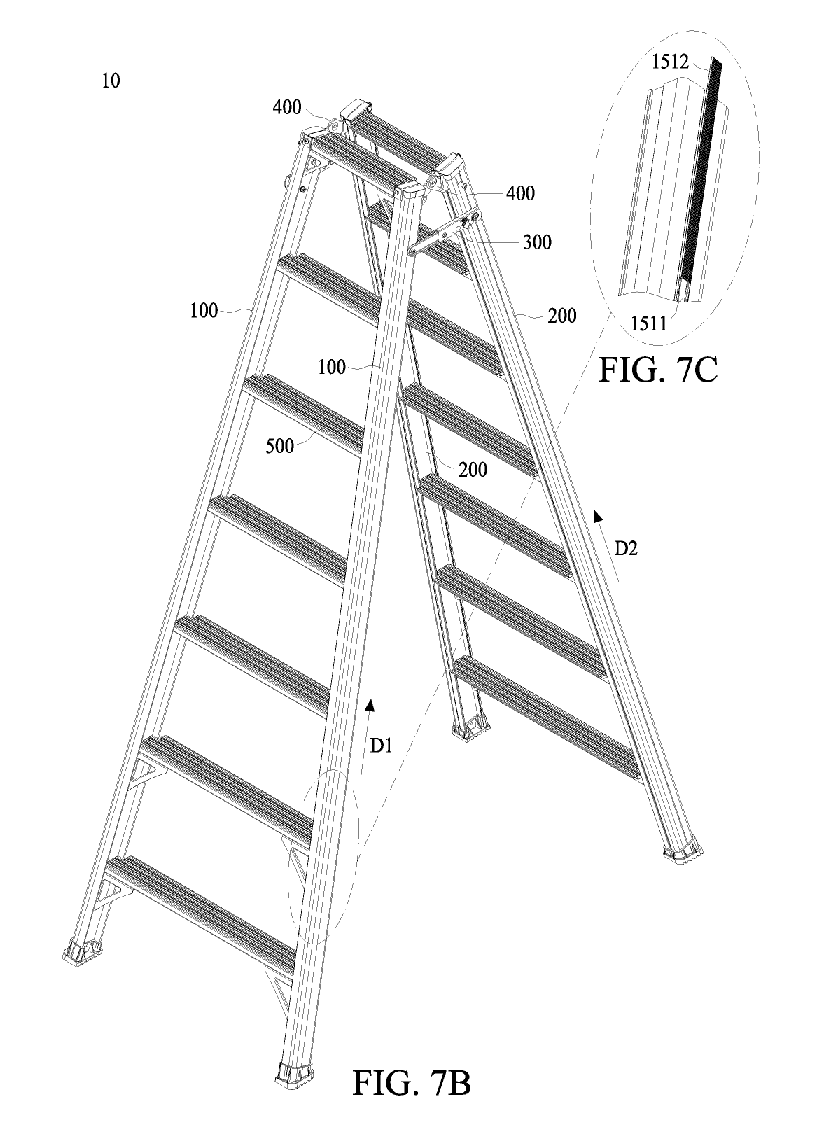

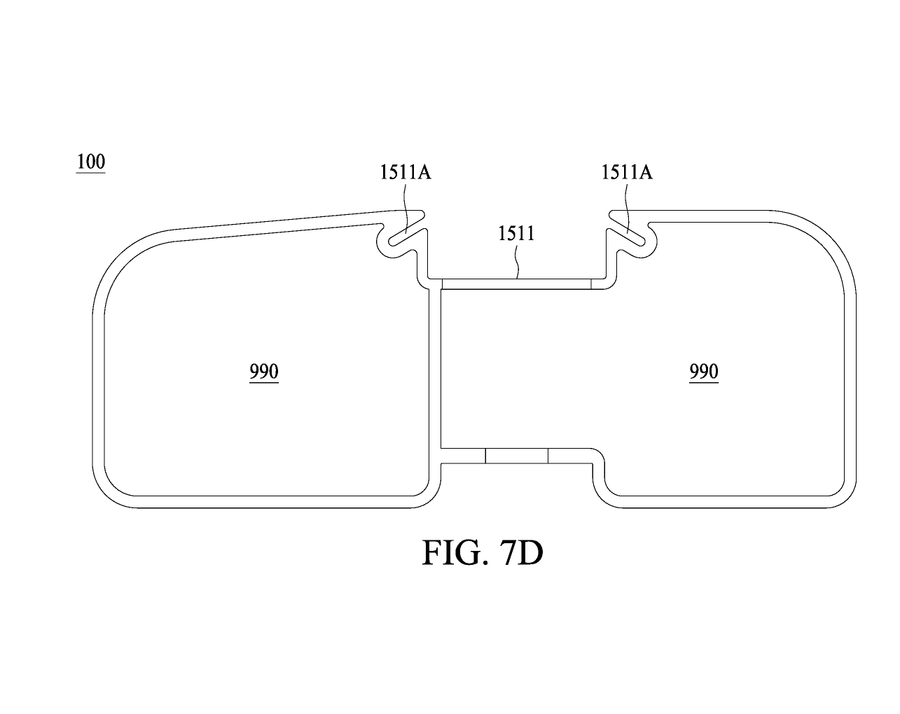

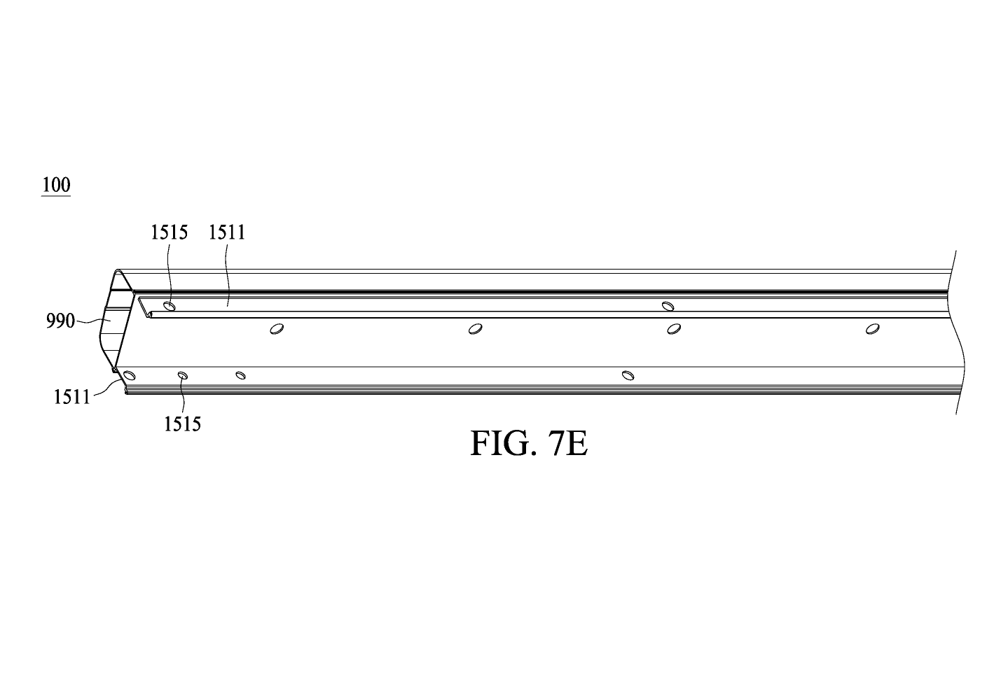

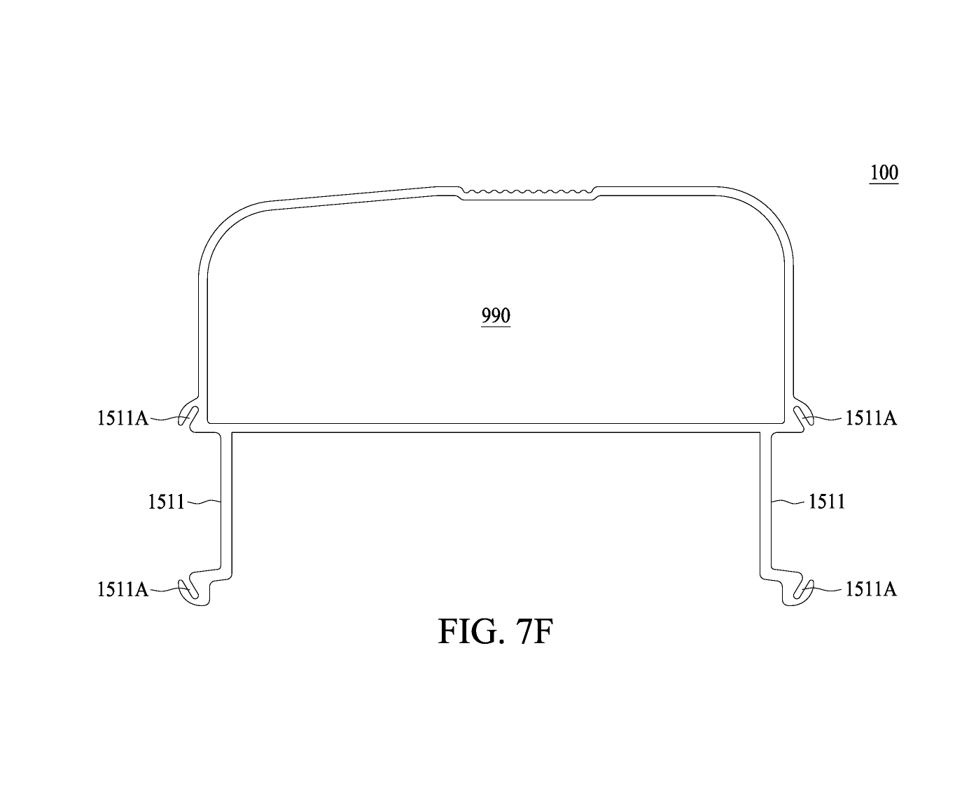

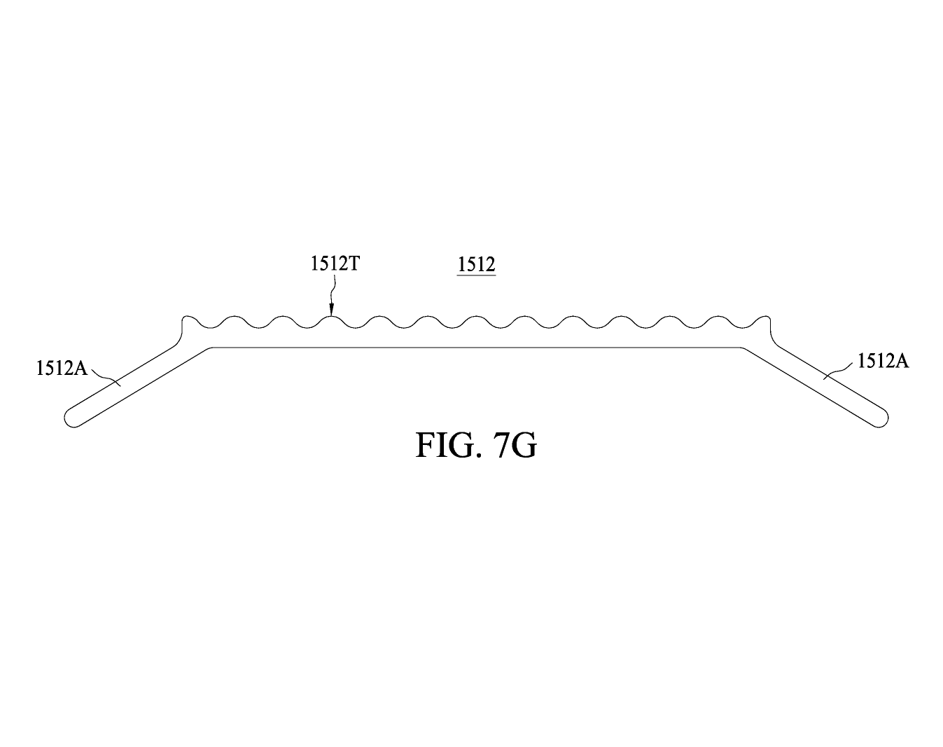

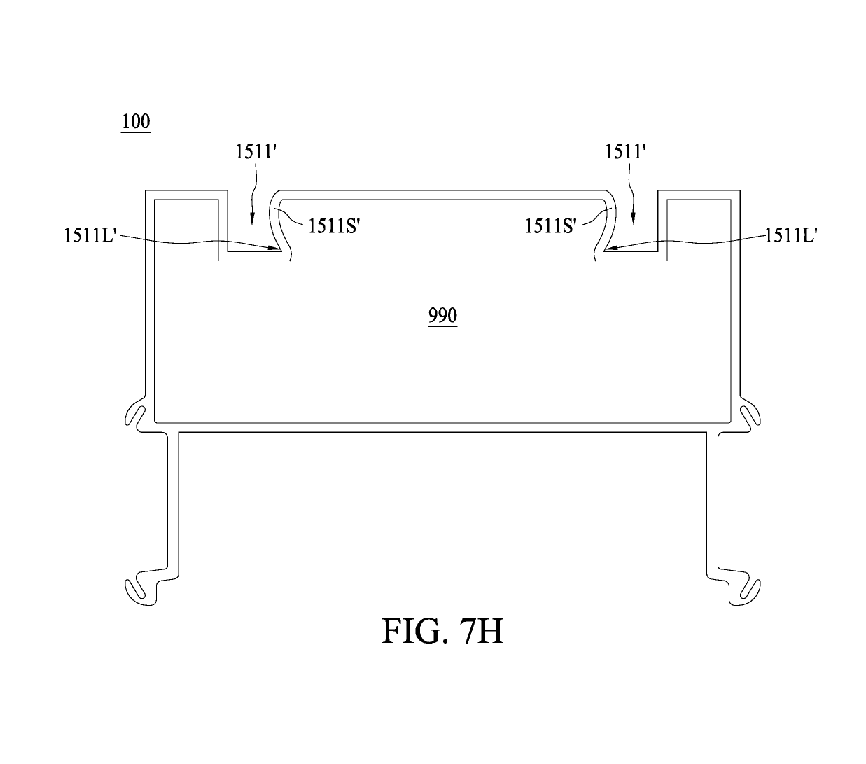

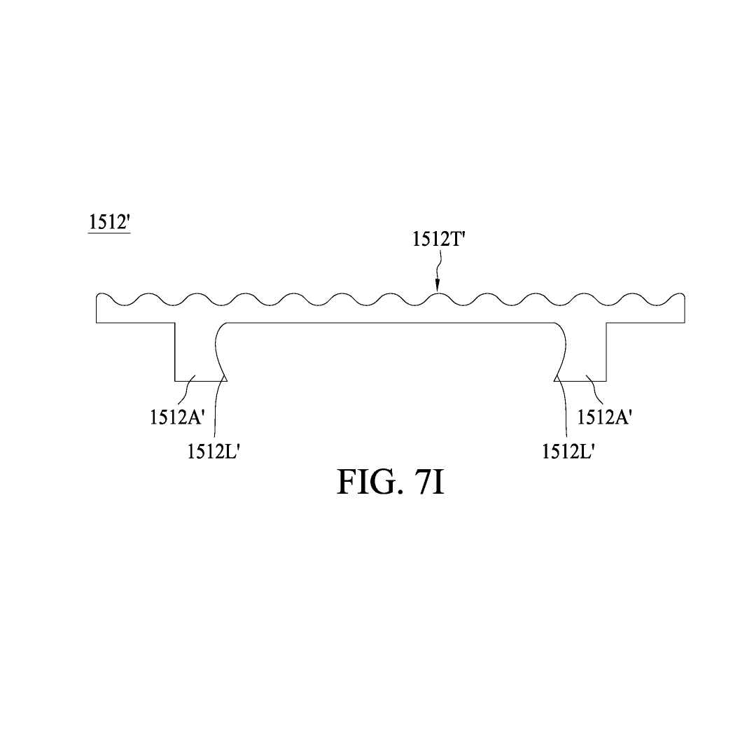

Referring to FIG. 7A, FIG. 7A is a perspective view of a first portion of a mechanical structure, in accordance with some embodiments of the present disclosure. In some embodiments, a recess 1511 is recessed on an outer surface of the first portion 100, wherein the recess 1511 extends in a first direction D1 along the first portion 100. The recess 1511 may help ameliorate mechanical strength, space reduction, or cost reduction, or in some embodiments, the recess 1511 may stem from limitation during fabrication. In some embodiments, the recess 1511 may include apertures 1515 or other protrusions, recesses, or other structures. However, such structures having acute edges may cause injury on a user such as incised wound.

Referring to FIG. 7B and FIG. 7C, FIG. 7B is a perspective view showing a mechanical structure, FIG. 7C is an enlarged schematic view of a first portion of a mechanical structure, in accordance with some embodiments of the present disclosure. In some embodiments, the second portion 200 may also include the recess 1511 similar to the first portion 100 thereof, wherein the recess (not shown in FIG. 7B and FIG. 7C) extends along a second direction D2 along the second portion 200. A strip 1512 may be disposed on an outer surface of the first portion 100 and/or an outer surface of the second portion 200 in order to cover the apertures 1515 or other protrusions, recesses, or other structures. The strip 1512 may extend along the same direction of the recess 1511.

Referring to FIG. 7D, FIG. 7D is a cross-sectional view of a first portion of a mechanical structure, in accordance with some embodiments of the present disclosure. A strip slot 1511A is disposed above the recess 1511 or on at least one sidewall of the recess 1511. In some embodiments, the strip slot 1511A is recessed in a direction toward the hollowed chamber 990 of the first portion 100 or the second portion 200. The strip slot 1511A may accommodate and engage the strip 1512 and thus prevent the strip slot 1511A from detachment. In some embodiments, the recess 1511 may be recessed from a surface which is connected to the first connector 300 or the second connector 300′.

Referring to FIG. 7E and FIG. 7F, FIG. 7E is a perspective view of a first portion of a mechanical structure, FIG. 7F is a cross-sectional view of a first portion of a mechanical structure, in accordance with some embodiments of the present disclosure. In some embodiments, the recess 1511 may be disposed on an extended portion connecting to the first portion 100 or the second portion 200, therefore the strip slot 1511A is disposed over the recess 1511 or on at least one sidewall of the recess 1511. The strip 1512 may extend along the same direction of the recess 1511.

Referring to FIG. 7G, FIG. 7G is a cross-sectional view of a strip, in accordance with some embodiments of the present disclosure. In order to ameliorate the engagement between the strip 1512 and the strip slot 1511A, the strip 1512 may include a protrusion portion 1512A to be inserted into the strip slot 1511A. The protrusion portion 1512A may match with the strip slot 1511A. In some embodiments, the strip 1512 may include an exposing top surface 1512T having a flat surface or a curved surface, so that acute edges causing injuries may be avoided.

Referring to FIG. 7H and FIG. 7I, FIG. 7H is a cross-sectional view of a first portion of a mechanical structure, and FIG. 7I is a cross-sectional view of a strip, in accordance with some embodiments of the present disclosure. In some embodiments, the first portion 100 and/or the second portion 200 may include a recess 1511′ (a variation of the recess 1511 discussed in FIG. 7D) to accommodate a strip 1512′ (a variation of the strip 1512 discussed in FIG. 7G). In order to ameliorate the engagement between the strip 1512′ and the recess 1511′, the recess 1511′ is recessed toward the hollowed chamber 990 as the recess 1511′ further includes a secondary recess 1511L′ recessed in a different direction than the recess 1511′ (e.g. substantially orthogonal to the recess 1511′); while the strip 1512′ may include a first portion 1512A′ to be disposed toward the hollowed chamber 990 and a second portion 1512L′ to be laterally extends from the first portion 1512A′. By such configuration, the second portion 1512L′ can mate with the secondary recess 1511L′, as a sidewall of the recess 1511′ may have an inward protrusion 1511S′ to prevent the strip 1512′ to be detached from the recess 1511′.

In some embodiments, the first portion 100 and/or the second portion 200 includes at least two recesses 1511′, as the strip 1512′ includes at least two first portions 1512A′ and the same number of second portions 1512L′ to match with the recess 1511′. In some embodiments, the strip 1512′ may include an exposing top surface 1512T′ having a flat surface or a curved surface, so that acute edges causing injuries may be avoided.

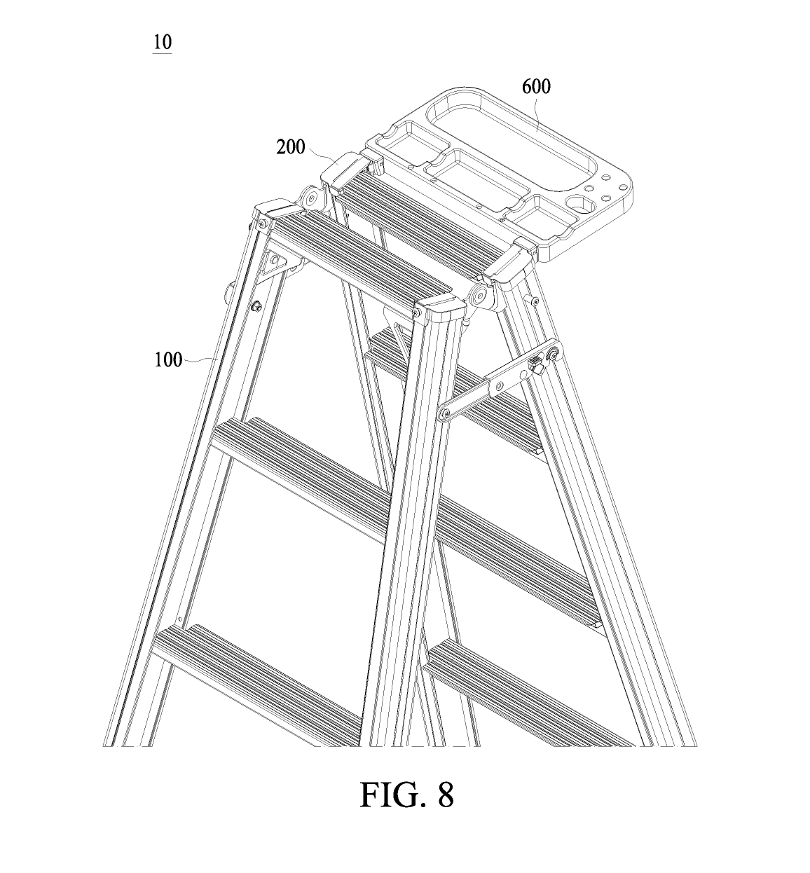

Referring to FIG. 8, FIG. 8 is an enlarged schematic view showing a top portion of a mechanical structure, in accordance with some embodiments of the present disclosure. In some embodiments, a trey 600 may be optionally disposed on the first portion 100 or the second portion 200. The trey 600 may provide extra storage, such as a platform for placing hand tools. In some embodiments, the trey 600 may include fast assembly structures for convenient attachment and detachment.

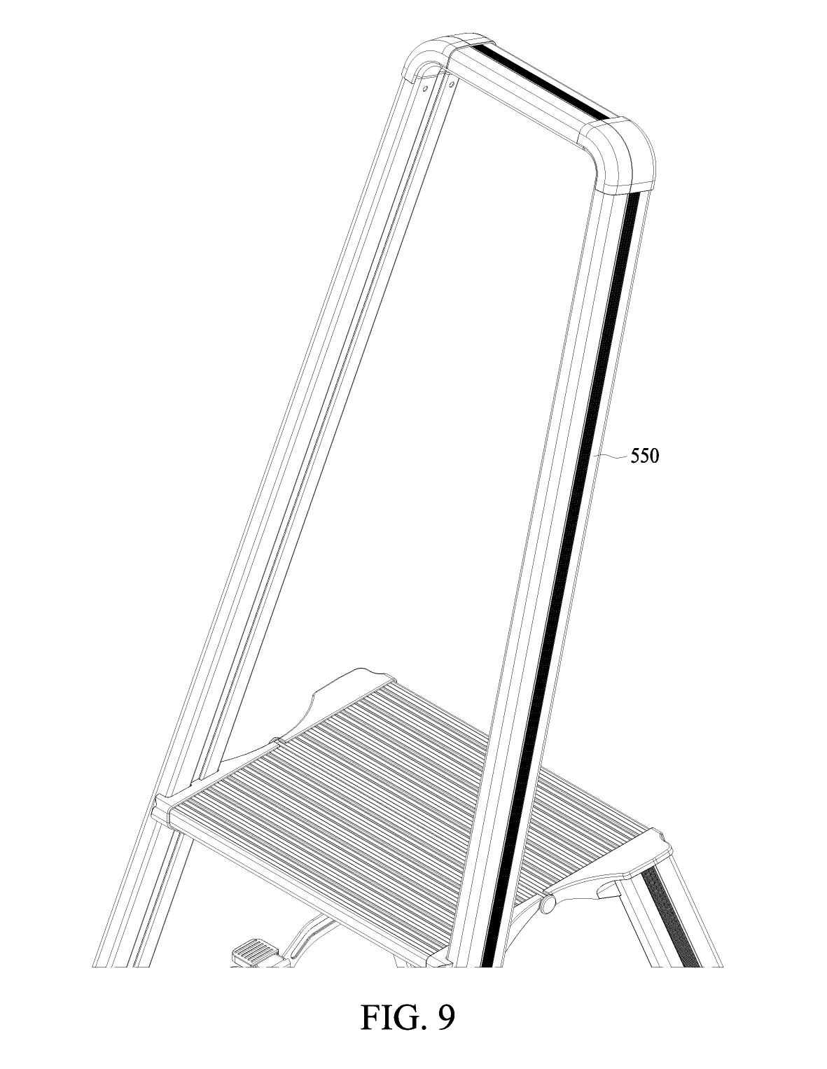

Referring to FIG. 9, FIG. 9 is an enlarged schematic view showing a top portion of a mechanical structure, in accordance with some embodiments of the present disclosure. In some embodiments, an extension structure 550 may be optionally disposed above the mechanical structure 10. The extension structure 550 may serve as a handle, or can be used for fixating a safety rope thereto.

Some embodiments of the present disclosure provide a mechanical structure, including a first portion, a second portion, the second portion including a first fixture, and a second fixture over the first fixture, a first connector, the first connector including a first end connected to the first portion, and a second end connected to the second portion, wherein the second end is connected to the first fixture when a first angle is between the first portion and the second portion, and the second end is connected to the second fixture when a second angle different from the first angle is between the first portion and the second portion.

Some embodiments of the present disclosure provide a mechanical structure, including a first portion, a second portion connected to the first portion, and a first connector connected to the first portion, the first connector including a first lever, a second lever, wherein the first lever and the second lever are connected by an elastic member, and a clip connected to the second lever.

Some embodiments of the present disclosure provide a mechanical structure, including a first portion having a first hollowed chamber, a hinge connected to the first portion, a second portion connected to the hinge, wherein the second portion has a second hollowed portion, a first connector having a first end connected to the first portion and a second end connected to the second portion, a second connector having a first end connected to the first portion and a second end connected to the second portion, a first fixing member to fixate the hinge to an inner surface of the first hollowed chamber, and a second fixing member to fixate the hinge to an inner surface of the second hollowed chamber.

The foregoing outlines features of several embodiments so that those skilled in the art may better understand the aspects of the present disclosure. Those skilled in the art should appreciate that they may readily use the present disclosure as a basis for designing or modifying other operations and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A mechanical structure, comprising:
a first portion;
a second portion, the second portion comprising:
a first fixture; and
a second fixture over the first fixture;
a first connector, the first connector comprising:
a first end connected to the first portion; and
a second end connected to the second portion, wherein the second end is connected to the first fixture when a first angle is between the first portion and the second portion, and the second end is connected to the second fixture when a second angle different from the first angle is between the first portion and the second portion.

2. The mechanical structure of claim 1, wherein the first connector further comprises a first link and a second link, a first end of the first link connected to the first portion, a second end of the first link connected to the second link, a first end of the second link connected to the first link, and a second end of the second link opposite to the first end of the second link.

3. The mechanical structure of claim 1, wherein the first connector comprises an operative portion, the operative portion controls the first connector to be fixated or unfixed from one of the first fixture and the second fixture.

4. The mechanical structure of claim 3, wherein the first connector comprises a clip to fixate the first connector to one of the first fixture and the second fixture.

5. The mechanical structure of claim 4, wherein the operative portion comprises a first lever and a second lever, wherein a first leverage angle is between the first lever and the second lever when the first connector is fixated to one of the first fixture and the second fixture, a second leverage angle different from the first leverage angle is between the first lever and the second lever when the clip is opened.

6. The mechanical structure of claim 1, wherein the second angle is 180 degrees.

7. The mechanical structure of claim 1, wherein the second portion have a hollowed chamber.

8. The mechanical structure of claim 7, wherein the hollowed chamber accommodates at least a portion of the first fixture.

9. The mechanical structure of claim 1, further comprising a second connector connected between the first portion and the second portion, wherein the second connector faces away from the first connector.

10. A mechanical structure, comprising:
a first portion;
a second portion connected to the first portion; and
a first connector connected to the first portion, the first connector comprising:
a first lever;
a second lever, wherein the first lever and the second lever are connected by an elastic member; and
a clip connected to the second lever.

11. The mechanical structure of claim 10, wherein the second portion comprises a first fixture and a second fixture above the first fixture.

12. The mechanical structure of claim 11, wherein a first leverage angle different from the first leverage angle is between the first lever and the second lever when the first connector is fixated to one of the first fixture and the second fixture, a second leverage angle is between the first lever and the second lever when the clip is disconnected from the first fixture and the second fixture.

13. The mechanical structure of claim 10, wherein the elastic member is a torsion spring.

14. The mechanical structure of claim 10, wherein the first lever is fixed on the first connector.

15. The mechanical structure of claim 10, further comprising a hinge connected the first portion and the second portion, wherein the hinge allows the first portion and the second portion to rotate around a rotational axis.

16. The mechanical structure of claim 15, wherein at least one of the first portion and the second portion has a hollowed chamber, the hinge is fixated to an inner surface of the hollowed chamber.

17. The mechanical structure of claim 10, wherein at least one of the first lever and the second lever is covered by sleeve.

18. The mechanical structure of claim 10, further comprising a second connector connected between the first portion and the second portion, wherein the second connector faces away from the first connector.

19. A mechanical structure, comprising:
a first portion having a first hollowed chamber;
a hinge connected to the first portion;
a second portion connected to the hinge, wherein the second portion has a second hollowed portion;
a first connector having a first end connected to the first portion and a second end connected to the second portion;
a second connector having a first end connected to the first portion and a second end connected to the second portion;
a first fixing member to fixate the hinge to an inner surface of the first hollowed chamber; and
a second fixing member to fixate the hinge to an inner surface of the second hollowed chamber.

20. The mechanical structure of claim 19, further comprising:
a strip disposed on an outer surface of the first portion; and
a recess to accommodate the strip, wherein the recess extends along the first portion.
